(19) United States
(12) Patent Application Publication
(10) Pub. No.: US 2016/0037568 A1
(43) Pub. Date: Feb. 4, 2016

(54) METHOD AND APPARATUS FOR REESTABLISHING COMMUNICATION WITH A NETWORK

(71) Applicants: Sami-Jukka HAKOLA, Kempele (FI); Samuli TURTINEN, Ii (FI); Chunyan GAO, (US); Timo Kalevi KOSKELA, Oulo (FI); BROADCOM CORPORATION, Irvine, CA (US)

(72) Inventors: Sami-Jukka HAKOLA, Kempele (FI); Samuli TURTINEN, Ii (FI); Chunyan GAO, Beijing (CN); Timo Kalevi KOSKELA, Oulu (FI)

(21) Appl. No.: 14/773,980

(22) PCT Filed: Mar. 29, 2013
(86) PCT No.: PCT/CN2013/073440

§ 371 Date: Sep. 9, 2015

(51) Int. Cl. H04W 76/02; H04W 72/08

(52) U.S. Cl. CPC H04W 76/023; H04W 72/085; H04W 88/04

(57) ABSTRACT

A method, apparatus and computer program product are provided to facilitate selection of other user equipment as a relay node in order to establish connection to a network, such as following a radio link failure. In the context of a method for establishing a device-to-device connection, signals may be received from a plurality of user equipment that indicates that the user equipment have relay capabilities. The method also includes selecting a respective user equipment to serve as a relay to a network based upon one or more parameters. The method also establishes a connection with the respective user equipment that relays messages to the network.

### TECHNOLOGICAL FIELD

An example embodiment of the present invention relates generally to the reestablishment of communication with a network and, more particularly, to the reestablishment of communication with a network utilizing user equipment that serves as a relay.

### BACKGROUND

User equipment may communicate with a network via a serving cell. In some instances, the user equipment may experience a radio link failure such that the connection between the user equipment and the serving cell fails. As the user equipment may desire to continue to communicate with the network, the user equipment may endeavor to reestablish a connection with the network via the serving cell. Sometimes, however, the user equipment may be unable to detect the serving cell or any other cell, e.g., any other Evolved Universal Mobile Telecommunications System Terrestrial Radio Access Network (EUTRAN) cells, on the frequency with which the user equipment previously communicating with the serving cell. As such, the user equipment may have to search for cells, such as EUTRAN or other 3^{rd} Generation Partnership Project (3GPP)—radio access technology (RAT) cells, operating on other frequencies.

Even in an instance in which the user equipment is able to establish a connection with a cell operating on another frequency, the communication between the user equipment and the network may be less efficient, at least initially.

### BRIEF SUMMARY

A method, apparatus and computer program product are provided in accordance with an example embodiment in order to utilize other user equipment as a relay in order to establish connection to a network, e.g., following a radio link failure. In an example embodiment, a method, apparatus and computer program product may select the other user equipment to serve as a relay to the network based on one or more parameters such that the resulting connection to the network may be established in an efficient manner, such as by selecting another user equipment to serve as a relay that is served by the same serving cell that was previously serving the user equipment that, for example, experienced the radio link failure. In another example embodiment, a method, apparatus and computer program product are provided that control the instances in which the user equipment broadcasts its relay capabilities so as to increase the likelihood that the user equipment will successfully serve as a relay to the network if selected by the user equipment that has experienced the radio link failure, for example.

In one embodiment, a method is provided for establishing a device-to-device connection that includes receiving signals from a plurality of user equipment that indicates that the user equipment have relay capabilities. The method also includes selecting a respective user equipment to serve as a relay to a network based upon one or more parameters. The method also establishes a connection with the respective user equipment that relays messages to the network.

In another embodiment, an apparatus is provided for establishing a device-to-device connection that includes at least one processor and at least one memory including computer program code with the at least one memory and a computer program code configured to, with the at least one processor, cause the apparatus at least to receive signals from a plurality of user equipment that indicates that the user equipment have relay capabilities. The at least one memory and the computer program code are also configured to, with the at least one processor, cause the apparatus to select a respective user equipment to serve as a relay to a network based upon one or more parameters. The at least one memory and the computer program code are also configured to, with the at least one processor, cause the apparatus to establish a connection with the respective user equipment that relays messages to the network.

In a further embodiment, a computer-readable medium is provided that includes a set of instructions which, when executed, cause a device-to-device connection to be established by the receipt of signals from a plurality of user equipment that indicates that the user equipment have relay capabilities. The set of instructions, when executed, also cause selection of a respective user equipment to serve as a relay to a network based upon one or more parameters. The set of instructions, when executed, also cause establishment of a connection with the respective user equipment that relays messages to the network.

In yet another embodiment, an apparatus is provided for establishing a device-to-device connection that includes means for receiving signals from a plurality of user equipment that indicates that the user equipment have relay capabilities. The apparatus also includes means for selecting a respective user equipment to serve as a relay to a network based upon one or more parameters. The apparatus also includes means for establishing a connection with the respective user equipment that relays messages to the network.

In one embodiment, a method is provided for establishing a device-to-device connection that includes determining, based on a condition of the user equipment, whether an indication of a relay capability of the user equipment is included in a signal. The method of this embodiment causes the signal to be transmitted. The signal selectively includes the relay capability of the user equipment depending upon the condition of the user equipment. The method also establishes a connection with other user equipment. In an instance in which the signal includes the relay capability of the user equipment, the method also causes a message to be relayed between the other user equipment and a network.

In another embodiment, an apparatus is provided for establishing a device-to-device connection that includes at least one processor and at least one memory including computer program code with the at least one memory and the computer program code configured to, with the at least one processor, cause the apparatus at least to determine, based on a condition of a user equipment, whether an indication of a relay capability of the user equipment is included in a signal. The at least one memory and the computer program code are also configured to, with the at least one processor, cause the apparatus to cause the signal to be transmitted. The signal selectively includes the relay capability of the user equipment depending upon the condition of the user equipment. The at least one memory and the computer program code are also configured to, with the at least one processor, cause the apparatus to establish a connection with other user equipment and to cause a message to be relayed between the other user equipment and a network in an instance in which the signal includes the relay capability of the user equipment.

In a further embodiment, a computer-readable medium is provided that includes a set of instructions which, when executed, cause a device-to-device connection to be established by the determination, based on a condition of the user equipment, of whether an indication of a relay capability of the user equipment is included in a signal. The set of instructions, when executed, also cause the signal to be transmitted. The signal selectively includes the relay capability of the user equipment depending upon the condition of the user equipment. The set of instructions, when executed, also cause the establishment of a connection with other user equipment and cause a message to be relayed between the other user equipment and a network in an instance in which the signal includes the relay capability of the user equipment.

In a further embodiment, an apparatus is provided for establishing a device-to-device connection that includes means for determining, based on a condition of user equipment, whether an indication of a relay capability of the user equipment is included in a signal. The apparatus also includes means for causing the signal to be transmitted. The signal selectively includes the relay capability of the user equipment depending upon the condition of the user equipment. The apparatus also includes means for establishing a connection with other user equipment and means, in an instance in which the signal includes a relay capability of the user equipment, for causing a message to be relayed between the other user equipment and a network.

In one embodiment, a method for use by a base station is provided that includes receiving a report from a relaying user equipment that identifies user equipment that seeks to establish communications. The method also determines whether the user equipment was previously served by the base station. In an instance in which the base station previously served the user equipment and in which a bearer remains configured, the method also continues with reestablishment of communications with the user equipment utilizing the bearer that was previously configured.

In another embodiment, an apparatus for use by a base station is provided that includes at least one processor and at least one memory including computer program code with the at least one memory and a computer program code configured to, with the at least one processor, cause the apparatus at least to receive a report from a relaying user equipment that identifies user equipment that seeks to establish communications. The at least one memory and the computer program code are also configured to, with the at least one processor, cause the apparatus to determine whether the user equipment was previously served by the base station. In an instance in which the base station previously served the user equipment and in which a bearer remains configured, the at least one memory and the computer program code are also configured to, with the at least one processor, cause the apparatus to continue with reestablishment of communications with the user equipment utilizing the bearer that was previously configured.

In a further embodiment, a computer-readable medium for use by a base station is provided that includes a set of instructions which, when executed, cause receipt of a report from a relaying user equipment that identifies user equipment that seeks to establish communications. The set of instructions, when executed, also determine whether the user equipment was previously served by the base station. In an instance in which the base station previously served the user equipment and in which a bearer remains configured, the set of instructions, when executed, also continue with reestablishment of communications with the user equipment utilizing the bearer that was previously configured.

In yet another embodiment, an apparatus for use by a base station is provided that includes means for receiving a report from a relaying user equipment that identifies user equipment that seeks to establish communications. The apparatus also includes means for determines whether the user equipment was previously served by the base station. In an instance in which the base station previously served the user equipment and in which a bearer remains configured, the apparatus also includes means for continuing with reestablishment of communications with the user equipment utilizing the bearer that was previously configured.

### BRIEF DESCRIPTION OF THE DRAWINGS

Having thus described certain example embodiments of the invention in general terms, reference will now be made to the accompanying drawings, which are not necessarily drawn to scale, and wherein:

FIG. 1 is a schematic representation of a system that includes user equipment that may be specifically configured in accordance with an example embodiment of the present invention in order to reestablish communication following a radio link failure;

FIG. 2 is a block diagram of an apparatus that may be specifically configured in accordance with an example embodiment of the present invention;

FIG. 3 is a flow chart illustrating operations performed, such as by the apparatus of FIG. 2 as embodied by user equipment seeking to reestablish communications, in accordance with an example embodiment of the present invention;

FIG. 4 is a signal flow diagram of the signals exchanged between a plurality of user equipment and a serving cell in accordance with an example embodiment of the present invention;

FIG. 5 is a flow chart illustrating operations performed, such as by the apparatus of FIG. 2 as embodied by a base station, in accordance with an example embodiment of the present invention; and

FIG. 6 is a flow chart illustrating operations performed, such as by the apparatus of FIG. 2 as embodied by relaying user equipment, in accordance with another example embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

A method, apparatus and computer program product are provided in accordance with an example embodiment in order to facilitate the reestablishment of a connection with a network, such as following a radio link failure or while out of coverage. In this regard, the method, apparatus and computer program product may utilize other user equipment to serve as a relay between the user equipment, such as the user equipment that experienced the radio link failure, and the network in an instance in which the user equipment is unable to reestablish a direct connection with the serving cell that previously served the user equipment. As described below, the method, apparatus and computer program product of the various example embodiments may control the instances in which the other user equipment may advertise its relay capabilities and/or the manner in which the other user equipment is selected to serve as a relay such that the resulting connection between the user equipment, such as the user equipment that experienced the radio link failure, and the network is established in an efficient manner.

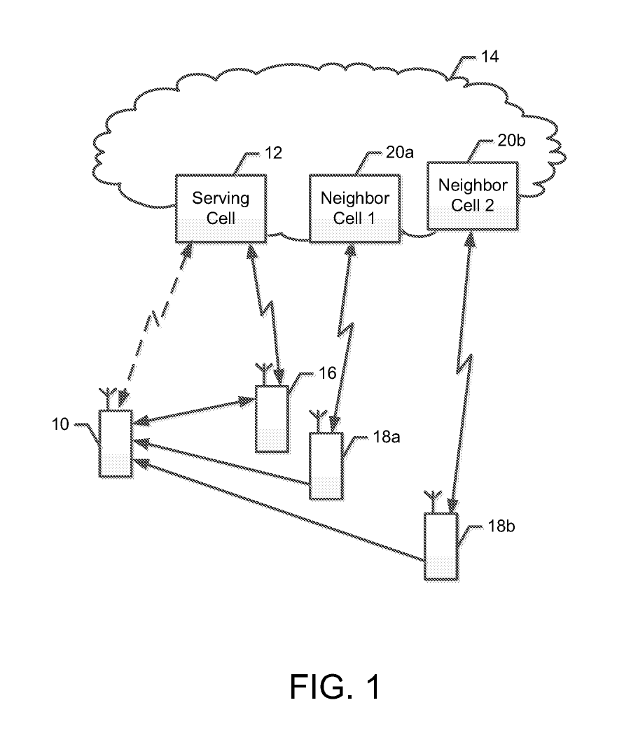

Referring now to FIG. 1, a system that includes a plurality of user equipment 10, 16, 18a, 18b that are configured to communication with a network 14 via respective cells 12, 20a, 20b is depicted. The user equipment may be embodied in various manners including, for example, as a mobile communication device or other type of mobile terminal such as, for example, a mobile telephone, portable digital assistant (PDA), pager, laptop computer, table computer, or any of numerous other hand held or portable communication devices, computation devices, content generation devices, content consumption devices, universal serial bus (USB) dongles, data cards or combinations thereof. Alternatively, the user equipment may be embodied as a fixed terminal, such as a personal computer, a computer workstation or the like.

Regardless of the manner in which the user equipment 10, 16, 18a, 18b is embodied, the user equipment is configured to communicate with a network 14 via cells 12, 20a, 20b. While the network may be configured in accordance with a Universal Mobile Telecommunications System (UMTS) Terrestrial Radio Access Network (UTRAN), the network may employ other mobile access mechanisms such as Long Term Evolution (LTE), LTE-Advanced (LTE-A), wideband code division multiple access (W-CDMA), CDMA2000, global system for mobile communications (GSM), general packet radio service (GPRS), wireless local area network (WLAN), WiMAX and/or the like.

The network 14 may include a collection of various different nodes, devices or functions that may be in communication with each other via corresponding wired and/or wireless interfaces. For example, the network may include one or more base stations, such as one or more node Bs, evolved node Bs (eNBs), access points, relay nodes or the like, each of which may serve a coverage area divided into one or more cells. For example, the network may include one or more cells, including a serving cell 12 and one or more neighbor cells 20a, 20b (designated neighbor cell 1 and neighbor cell 2 in the embodiment of FIG. 1), each of which may serve a respective coverage area. The serving cell and the neighbor cells could be, for example, part of one or more cellular or mobile networks or public land mobile networks (PLMNs).

As shown in FIG. 1 from the perspective of user equipment 10, the user equipment 10 communicates with the network 14 via a serving cell 12, while other user equipment communicates with the network via the same or different cells. For example, user equipment 16 may also communicate with the network via the serving cell 12, while user equipment 18a, 18b that are disposed in proximity to the user equipment 10, 16 may also communicate with a network via one or more different cells, such as neighbor cell 1 and neighbor cell 2. The user equipment may be proximate one another and, in one embodiment, may be configured to support proximity services as defined by 3GPP. In this regard, the user equipment may be considered to be proximate one another 10 if the user equipment is capable of directly communicating with one another. As such, in addition to network-based communication, the user equipment may also be configured to communicate directly with one another. The user equipment may communicate directly with one another via various communication techniques, such as proximity-based communication techniques, e.g., Bluetooth, Wi-Fi, wireless local area network (WLAN) or the like.

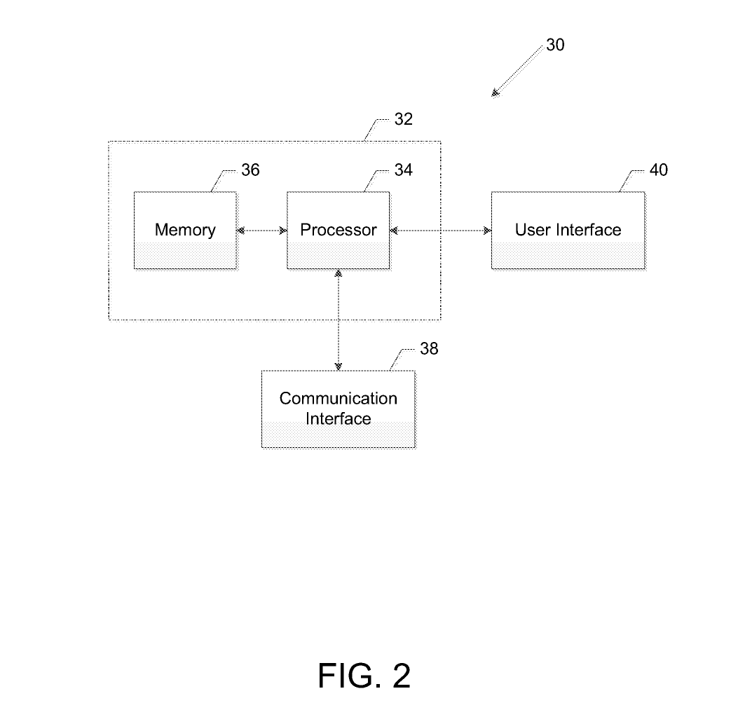

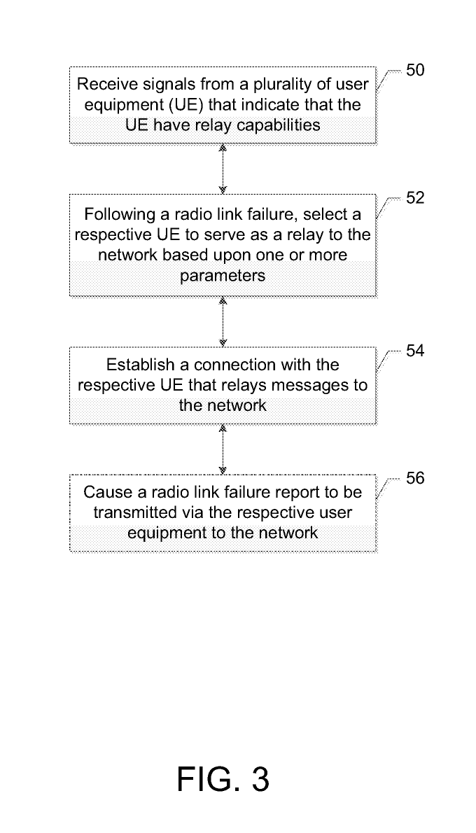

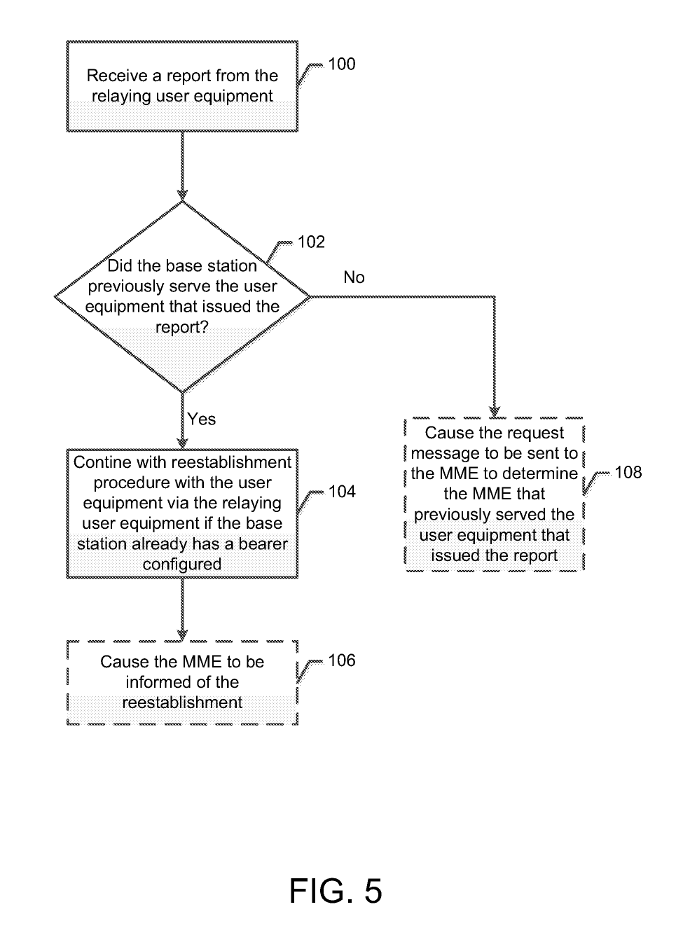

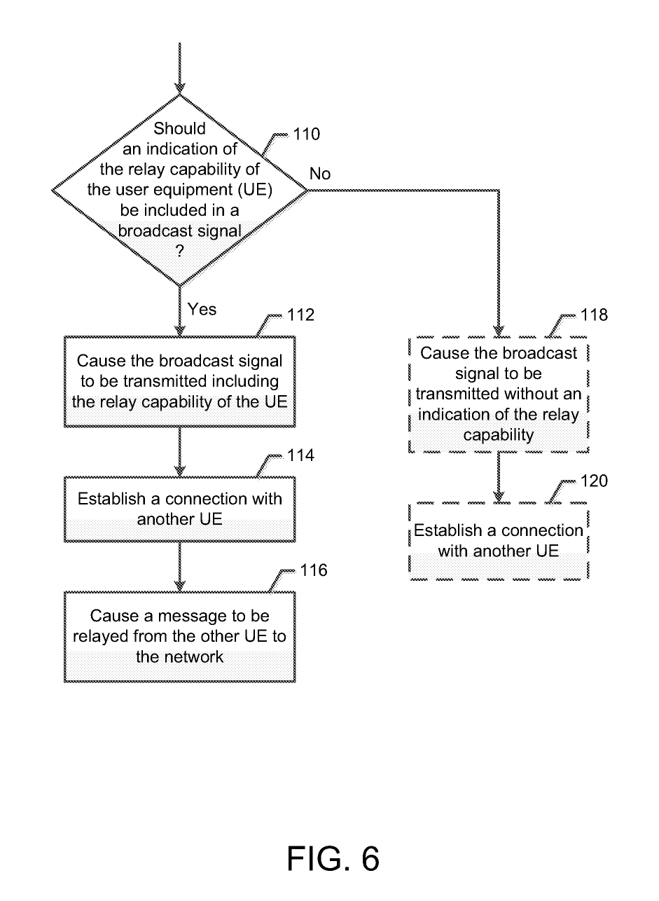

The user equipment and/or a base station may implement example embodiments of the method, apparatus and computer program product in order to provide for reestablishing communication with a network, such in an instance in which a user equipment suffers a radio link failure. In this regard, the user equipment may embody or otherwise be associated with an apparatus 30 that is generally depicted in FIG. 2 and that may be configured in accordance with an example embodiment of the present invention as described below, such as in conjunction with FIG. 3 from the perspective of the user equipment 10 that suffers a radio link failure, FIG. 5 from the perspective of the base station that communicates with the relaying user equipment 16 and FIG. 6 from the perspective of the user equipment 16 that serves as a relay in conjunction with the reestablishment of communication with the network. However, it should be noted that the components, devices or elements described below may not be mandatory and thus some may be omitted in certain embodiments. For example, an apparatus embodied by a base station may not necessarily include a user interface in the manner described below. Additionally, some embodiments may include further or different components, devices or elements beyond those shown and described herein.

As shown in FIG. 2, the apparatus 30 may include or otherwise be in communication with a processing system including, for example, processing circuitry 32 that is configurable to perform actions in accordance with an example embodiment described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 32 may include a processor 34 and memory 36 that may be in communication with or otherwise control a communication interface 38 and, in some embodiments, a user interface 40. As such, the processing circuitry may be embodied as a circuit chip (e.g., an integrated circuit chip) configured (e.g., with hardware, software or a combination of hardware and software) to perform operations described herein. However, in some embodiments, the processing circuitry may be embodied as a portion of user equipment.

The user interface 40 may be in communication with the processing circuitry 32 to receive an indication of a user input at the user interface and/or to provide an audible, visual, mechanical or other output to the user. As such, the user interface may include, for example, a keyboard, a mouse, a joystick, a display, a touch screen, a microphone, a speaker, and/or other input/output mechanisms. In one embodiment, the user interface includes user interface circuitry configured to facilitate at least some functions of the user equipment by receiving user input and providing output.

The communication interface 38 may include one or more interface mechanisms for enabling communication with other devices and/or networks. In some cases, the communication interface may be any means such as a device or circuitry embodied in either hardware, or a combination of hardware and software that is configured to receive and/or transmit data from/to a network 14 and/or any other device or module in communication with the processing circuitry, such as between the plurality of user equipment. In this regard, the communication interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 36 may include one or more non-transitory memory devices such as, for example, volatile and/or non-volatile memory that may be either fixed or removable. The memory may be configured to store information, data, applications, instructions or the like for enabling the apparatus 30 to carry out various functions in accordance with example embodiments of the present invention. For example, the memory could be configured to buffer input data for processing by the processor 34. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 34 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 36 or otherwise accessible to the processor. As such, whether configured by hardware or by a combination of hardware and software, the processor may represent an entity (e.g., physically embodied in circuitry—in the form of processing circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

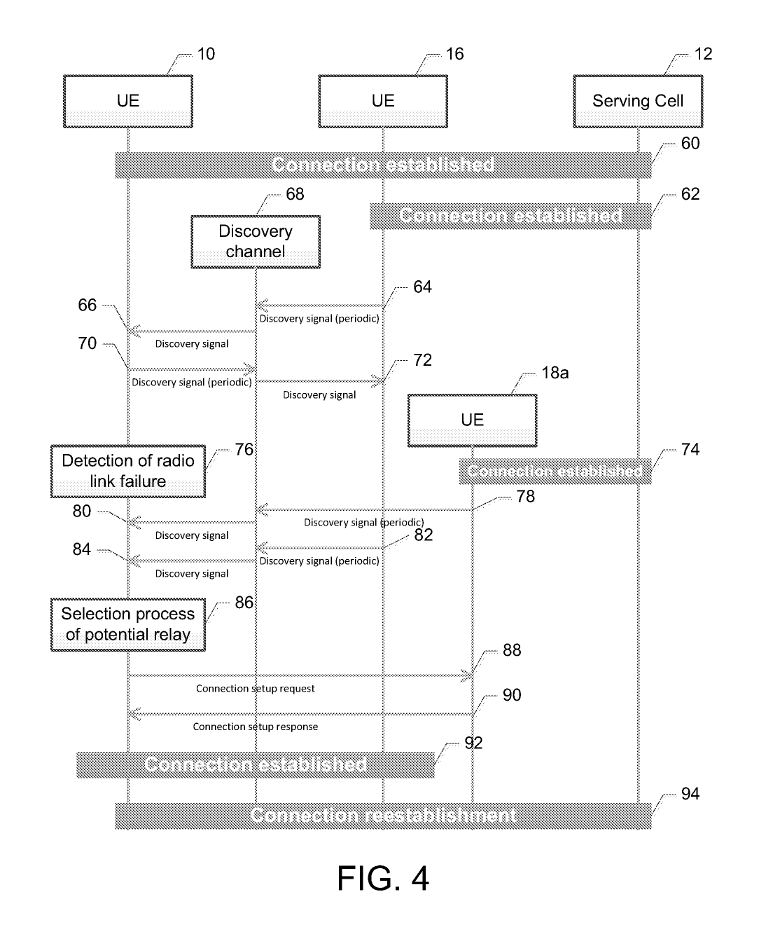

Referring now to FIG. 3, the operations performed, such as by the apparatus 30 of FIG. 2 embodied by or associated with the user equipment 10 that wishes to connect, or reconnect, with the network, are illustrated. By way of example, the user equipment will be described in regards to user equipment that experienced a radio link failure and that desires to reconnect with the network. However, the user equipment may wish to identify a relay for other reasons including instances in which the user equipment is outside the network coverage and must utilize a relay to connect to the network or in instances in which the user equipment is connected to the network but notices that the quality of the link has fallen below a predetermined threshold and wishes to identify a relay for precautionary purposes in case the link subsequently fails. As shown in block 50 of FIG. 3, the apparatus may include means, such as the processing circuitry 32, the processor 34, the communication interface 38 or the like, for receiving signals from a plurality of other user equipment 16, 18a, 18b that indicate that the other user equipment have relay capabilities. The signals received from the plurality of other user equipment may be received prior to the radio link failure and/or following the radio link failure. As shown by the signal flow diagram of FIG. 4, the user equipment 10 may establish a connection to a serving cell 12, such as an EUTRAN cell utilizing Evolved Packet-switched System (EPS) bearers. While the user equipment is connected to the serving cell as shown at block 60, other user equipment 16, 18a, 18b, such as other user equipment 16 in the proximity of user equipment 10, may broadcast signals 64, such as discovery signals that are periodically broadcast 66 via the discovery channel 68. Similarly, the user equipment 10 may broadcast signals 70 to the other user equipment 16, 18a, 18b in proximity to user equipment 10, such as discovery signals broadcast 72 on a periodic basis via the discovery channel 68 to the other user equipment. As shown, the other user equipment 16, 18a may also have established respective connections with a cell, such as the serving cell, in order to communicate with the network 14. See blocks 62 and 74.

In addition or alternatively, following radio link failure which terminates the connection between the user equipment 10 and serving cell 12, the user equipment 10 may receive signals from a plurality of other user equipment 16, 18a, 18b located proximate the user equipment 10. As shown in FIG. 4, user equipment 10 may receive signals 100, 104, such as periodic discovery signals 78, 82 broadcast via the discovery channel 68, from a plurality of other user equipment 16, 18a following radio link failure 76 with the serving cell. Regardless of whether the signals received by the user equipment from the other user equipment are broadcast prior to or following the radio link failure, the signals may include an indication of the relay capabilities of the other user equipment and, in one embodiment, the identity of the cell that is serving the other user equipment, as described below.

As shown in block 52 of FIG. 3 and in block 86 of FIG. 4, the apparatus 30 embodied by or associated with user equipment 10 may also include means, such as the processing circuitry 32, the processor 34 or the like, for selecting, following the radio link failure, a respective one of the other user equipment 16 to serve as a relay to the network 14 based upon one or more parameters. The apparatus, such as the processing circuitry, the processor or the like, may select the other user equipment based upon consideration of a variety of parameters.

By way of example, the apparatus 30, such as the processing circuitry 32, the processor 34 or the like, may select the respective one of the other user equipment 16 to serve as a relay based upon the serving cell of the other user equipment. In some embodiments, the serving cell 12 that communicated with the user equipment 10 prior to the radio link failure may include data or other information relating to the user equipment 10 or the prior communication session that would be useful in the instance in which the connection are reestablished, such as by increasing the efficiency with which the connection may be reestablished. As such, the apparatus, such as the processing circuitry, the processor or the like, may select the respective user equipment 16 to serve as a relay based upon whether the respective user equipment is served by the same serving cell 12 that served user equipment 10 prior to the radio link failure. In an instance in which a respective one of the other user equipment 16 is served by the same serving cell that served the user equipment 10 prior to the radio link failure, the respective user equipment may be selected to serve as the relay or the respective user equipment may be prioritized in regards to the selection of user equipment to serve as a relay to the network.

An additional or alternative parameter that may be considered in regards to the selection of a respective one of the other user equipment 16 to serve as a relay to the network 14 is the signal strength between the user equipment 10 and the other user equipment that is under consideration for purposes of serving as a relay to the network. In this regard, user equipment having greater signal strength with the user equipment 10 may be selected or otherwise prioritized in regards to the selection of the other user equipment to serve as a relay to the network relative to other user equipment having a lower signal strength. Additionally or alternatively, the relaying capability level of the other user equipment may be a parameter that is considered in regards to the selection of a respective one of the other user equipment 16 to serve as a relay to the network. In this regard, the relay capability that is included within the signals, e.g., the discovery signals, transmitted by the other user equipment and received by user equipment 10 may include a relaying capability level of the user equipment including, for example, information regarding the link capacity and/or quality between the other user equipment and its serving cell. In this regard, user equipment having better link capacity and/or quality may be selected or prioritized in regards to the selection of a respective one of the other user equipment to serve as a relay to the network in an instance in which there is a plurality of relay capable user equipment available. Link capacity and/or quality is provided by way of an example, but the relaying capability level may include other parameters that may be considered by the user equipment 10 in selecting a relay capable user equipment 16, such as the mobility/velocity of the relay capable user equipment, available resources for relaying in that the relay capable user equipment may already serve some other user equipment as a relay and/or the relay capable user equipment may have its own application session configured, etc.

In an example embodiment, the relay capability may be a one bit information field that is included in the broadcast signal to indicate that the user equipment 16 can relay data. Relay capable user equipment 16 can also be out of network, e.g., EUTRAN or other radio access network, coverage, e.g., can relay data between two user equipment that out of network coverage. Thus, the relay capability of an example embodiment may indicate that the user equipment 16 is relay capable and has a connection to the network, e.g., EUTRAN. As such, the relay capability may provide an indication of the relay capability to reveal that the user equipment 16 can act as a relay, such as may be provided by a single bit and, in one embodiment, may also include an indication as to whether the user equipment that can act as a relay is connected to the network, e.g., EUTRAN, such as may be provided with a n additional bit. In instances in which the relay capability includes an indication as to whether a relay capable user equipment 16 is connected to the network, e.g., EUTRAN, the relay capability of an example embodiment may also provide an indication of the cell to which the relay capable user equipment is connected.

In one embodiment, the apparatus 30 embodied by or associated with the user equipment 10 may include means, such as the processing circuitry 32, the processor 34 or the like, for establishing relative priorities for the one or more parameters that are considered during the selection of a respective one of the other user equipment 16 to serve as a relay to the network 16. Although the relative priorities may be established in various manners, the apparatus, such as the processing circuitry, the processor or the like, may establish the relative priorities for the one or more parameters by individually weighting the one or more parameters. Although the parameters may be weighted in various manners, the apparatus, such as the processing circuitry, the processor or the like, may define a decision variable that provides an objective measure of the suitability or desirability of the other user equipment to serve as a relay to the network as follows:

Decision_Variableᵢ=Af(t)+BSᵢ+CKᵢ.

wherein i is an index identifying a respective one of the other user equipment that is under consideration and A, B and C are weights, e.g., scaling factors, associated with three different parameters, f(t), Sᵢ and Kᵢ, respectively. The weights may be defined in various manners and, in one example embodiment, the sum of A, B and C is equal to 1. By individually weighting the different parameters, the relative priority of the different parameters in regards to the selection of a respective one of the other user equipment to serve as the relay to the network 14 may be defined, such as by an operator, by the specification governing the operation of the system or otherwise. For example, the weights may be configured by the Evolved Packet Core (EPC), such as a mobility management entity (MME) or a ProSe server connected to an MME, on the non-access stratum (NAS) layer or by an eNB on the Radio Resource Control (RRC). Additionally or alternatively, default values of the weights may be stored by the universal subscriber identity module (USIM) of the user equipment that may have been set by the operator for the case in which the user equipment is switched on when there is no network coverage and no possibility for NAS or RRC level configuration by network. Configuration by the network could occur when user equipment attaches to the network or when user equipment requests to activate the ProSe feature. Although various parameters may be considered during the selection of a respective one of the other user equipment to serve as a relay to the network 14, in one embodiment, Sᵢ is the signal strength of the respective user equipment and Kᵢ is the relaying capability level of the respective user equipment.

In regards to establishing the relative priorities for the parameters, the apparatus 30 embodied by or associated with the user equipment 10 may optionally include means, such as the processing circuitry 32, the processor 34 or the like, for modifying the priority of a respective parameter as a function of time. As exemplified by the foregoing equation, a scaling factor associated with the serving cell of a respective one of the other user equipment that is under consideration for selection as a relay to the network 14 may be modified by a function f(t) that is dependent upon time t. In this regard, the time may commence and be measured from the point in time at which the user equipment 10 receives notification of the radio link failure with respect to the serving cell 12. In this regard, the weighting factor A associated with the serving cell of a respective one of the other user equipment that is under consideration for selection as a relay to the network may have a predefined non-zero value in an instance in which the same serving cell 12 serves both the respective user equipment 16 that is under consideration to serve as a relay to the network and the user equipment 10 that suffered the radio link failure and may have a different value, such as zero, in an instance in which different serving cells serve the respective user equipment that is under consideration for selection as a relay to the network and the user equipment 10 that experienced the radio link failure.

As such, the weighting factor A may give priority to the respective user equipment 16 that is served by the same serving cell 12 and which may therefore have data or other information associated with user equipment 10 that experienced the radio link failure that may serve to increase the efficiency with which a connection may be reestablished. However, the value of the data or other information stored by the serving cell 12 relating to the user equipment 10 that experiences the radio link failure decreases over time and may be removed from the buffer of the serving cell after a predefined period of time. Because of the decreasing value of the data or other information stored by the serving cell, the weighting factor A may be modified by a time-dependent function f(t). The time-dependent function f(t) is a non-increasing function over time that may reach a value of zero after a predetermined period of time which may equal or be shorter than the period of time for which the serving cell will store data or other information relating to the user equipment 10 that experienced the radio link failure.

In one embodiment, the function f(t) may be configured by the network 14 using the same mechanism as described above in conjunction with the weights or f(t) may be written into the governing specifications. Sᵢ may be measured by the user equipment 10 seeking a relay and Kᵢ may be the relaying capability level of a candidate relay user equipment 16, 18a, 18b announced by the relay capable user equipment in a signal, e.g., relay capable user equipment sends a signal, e.g., a broadcast signal, including relay capability information. The user equipment 10 looking for a relay may measure the received signal quality of the signal and determine Sᵢ (with i indicating a specific relay capable user equipment), and also Kᵢ by reading the relay capability level from signal sent by relay i.

By comparing the decision variables associated with each of the plurality of other user equipment that are evaluated in regards to service as a relay to the network 14, the apparatus 30, such as the processing circuitry 32, the processor 34 or the like, may select a respective one of the other user equipment to serve as the relay, such as by selecting the respective one of the other user equipment having the largest decision variable. Thereafter, the apparatus embodied by or otherwise associated with user equipment 10 may include means, such as the processing circuitry, the processor, the communication interface 38 or the like, for establishing a connection with the respective one of the other user equipment 16 that was selected and that will thereafter relay messages to the network 14 on behalf of user equipment 10. See block 54 of FIG. 3. With reference to FIG. 4, for example, the user equipment may issue a connection setup request 88 to user equipment 16 which may then respond with a connection setup response 90. Thereafter, a connection may be established between user equipment 10 and user equipment 16. User equipment 16 may then serve to relay messages between user equipment 10 and the network so as to effectively reestablish connection therebetween, as also shown in blocks 92 and 94 of FIG. 4.

By serving as a relay for user equipment 10 to communicate with the network 14, the communication load carried by user equipment 16 may increase. As such, the apparatus 30 embodied by or associated with user equipment 10 may also include means, such as the processing circuitry 32, the processor 34, the communication interface 38 or the like, for causing a radio link failure report to be transmitted via relaying user equipment 16 to an access point of the network 14. See block 56 of FIG. 3. The radio link failure report mode may include an identity of the serving cell 12 that was utilized, such as prior to the radio link failure. In addition, the radio link failure report may include one or more identities associated with user equipment 10, such as the System Architecture Evolution (SAE) Temporary Mobile Subscribe Identity (S-TMSI), Globally Unique Temporary User Equipment (UE) Identity (GUTI) or the like. Based upon the information provided by the radio link failure report, the access point may be able to determine the bearers, e.g., the S1 and S5 bearers, that are still existing that previously served user equipment 10, such as prior to the radio link failure. As described below, the network 14 may be able to restore those bearers and redirect the bearers, e.g., the S1 bearer(s), to the cell that is currently serving user equipment 16 that serves to relay messages between user equipment 10 and the network. Although the radio link failure report may be transmitted in various manners, the apparatus, such as the processing circuitry, the processor, the communication interface or the like, may transmit the radio link failure report via a RRC message, e.g., a RRCReestablishmentRequest message, as defined by the LTE RRC specification.

As shown in FIG. 5 from the perspective of a base station, e.g., eNB, in communication with the relaying user equipment 16, an apparatus 30 embodied by the base station may include means, such as the processing circuitry 32, the processor 34, the communication interface 38 or the like for receiving a report, such as a radio link failure report, from the user equipment 10 via relaying user equipment 16. See block 100 of FIG. 5. The apparatus 30 embodied by the base station may include means, such as the processing circuitry 32, the processor 34 or the like, for determining whether the base station served the user equipment 10 that issued the report earlier, such as within a predefined time period, based on, for example, an identification of the user equipment 10, e.g., the system architecture evolution (SAE) temporary mobile subscriber identity (S-TMSI), included in the report. See block 102. If the base station previously served the user equipment and if the base station still has a bearer, such as the S1 user plane bearer, configured, the apparatus 30 embodied by the base station may include means, such as the processing circuitry 32, the processor 34, the communication interface 38 or the like, for continuing with RRC reestablishment procedure with the user equipment 10 outside the EUTRAN coverage via the relaying user equipment 16. See block 104. In this instance, the apparatus 30 embodied by the base station may also include means, such as the processing circuitry 32, the processor 34, the communication interface 38 or the like, for causing the MME to be informed regarding the reestablishment. See block 106. By utilizing the previously configured S1 user plane bearer, the reestablishment process may be accomplished in an efficient manner.

Alternatively, if the base station did not previously serve the user equipment 10, the apparatus 30 embodied by the base station may include means, such as the processing circuitry 32, the processor 34, the communication interface 38 or the like, for causing a request message to be sent to the MME. See block 108 of FIG. 5. The MME of this embodiment may then check, such as based on the S-TMSI or GUTI in the report, whether the MME or some other MME was serving that user equipment 10 that issued the report, such as within a predefined time period (since the S-TMSI and GUTI may include information about the MME that previously served the user equipment 10). In the latter case, the MME may forward the request to the MME that previously served the user equipment 10 (termed the “serving MME”). The serving MME may then setup the S1 bearer between the serving gateway (S-GW) and the base station, e g., the eNB, that is serving the relaying user equipment 16. In case the S5/S8 bearer between packet data network (PDN) gateway (P-GW) and the S-GW is no longer configured for the user equipment 10, the MME could also initiate the existing attach procedure for the user equipment to setup the whole EPS bearer.

Referring now to FIG. 6, the operations performed by an apparatus 30 embodied by or otherwise associated with the user equipment 16 that is selected to serve as a relay between user equipment 10 and the network 14 are illustrated. In this embodiment, the apparatus may include means, such as the processing circuitry 32, the processor 34 or the like, for determining, based on a condition of the user equipment, whether an indication of the relay capability of the user equipment should be included in a broadcast signal, such as a discovery signal, transmitted to other user equipment that are proximately located. See block 110. In this regard, there may be one or more conditions in which the user equipment 16 would be unable to serve as a relay or would be inefficient in serving as a relay and, in those instances, may elect not to advertise its relay capabilities in the broadcast signals, such as discovery signals.

For example, the apparatus 30, such as the processing circuitry 32, the processor 34 or the like, may determine the velocity of the user equipment 16 that embodies or is otherwise associated with the apparatus and may determine whether the indication of the relay capability of the user equipment should be included in the broadcast signal based upon the velocity of the user equipment. For example, the apparatus, such as the processing circuitry, the processor or the like, may include the relay capability of the user equipment in the broadcast signal in an instance in which the velocity of the user equipment does not exceed a predefined threshold since user equipment that that is stationary or is moving slowly may serve as a relay for an extended period of time. Conversely, the apparatus, such as the processing circuitry, the processor or the like, may not include the relay capability of the user equipment in the broadcast signal in an instance in which the velocity of the user equipment exceeds the predefined threshold since user equipment moving at higher velocities may be less likely to serve as a relay for any extended period of time.

Additionally or alternatively, the apparatus 30, such as the processing circuitry 32, the processor 34 or the like, may determine the relative signal strength between the user equipment 16 that embodies or is otherwise associated with the apparatus and each of a serving cell 12 and one or more neighboring cells 20a, 20b. The apparatus of this example embodiment, such as the processing circuitry, the processor or the like, may determine a ratio of the signal strength to the serving cell to the signal strength to one or more neighboring cells, e.g., the neighboring cell having the best signal strength, and may determine whether to include an indication of the relay capability of the user equipment in the broadcast signal based upon the relative signal strengths to a serving cell and to one or more neighboring cells. In an example embodiment, the apparatus, such as the processing circuitry, the processor or the like, may include the relay capability of the user equipment in the broadcast signal in an instance in which the ratio of the signal strength of the serving cell to the signal strength to each neighboring cell exceeds a predetermined threshold, but may not include the relay capability of the user equipment in the broadcast signal in an instance in which the ratio of the signal strength to the serving cell to the signal strength to each neighboring cells is less than a predefined value since the user equipment can more effectively and efficiently serve as a relay in an instance in which its signal strength to the serving cell is substantially greater than its signal strength to one or more neighboring cells.

Additionally or alternatively, a condition that may be considered in regards to determining whether to include an indication of the relay capability of the user equipment in a broadcast signal may be whether the user equipment is engaged in a handover process or is soon to be engaged in a handover process. In an instance in which the apparatus 30, such as the processing circuitry 32, the processor 34 or the like, determines that the user equipment is engaged in a handover process or is soon to be engaged in a handover process, the apparatus, such as the processing circuitry, the processor or the like, may determine that the relay capability of the user equipment should not be included in the broadcast signal. Conversely, in an instance in which the apparatus, such as the processing circuitry, the processor or the like, determines that the user equipment is not engaged in a handover process and is not soon to be engaged in a handover process, the apparatus, such as the processing circuitry, the processor or the like, may include the indication of the relay capability of the user equipment in the broadcast signal, subject to consideration of any other conditions. Alternatively, in an instance in which the user equipment is determined to be engaged in a handover process or to soon be engaged in a handover process, the user equipment may be prevented from transmitting broadcast signals, such as discovery signals.

In an instance in which the indications of the relay capability of the user equipment is to be included in a broadcast signal, the apparatus 30 may include means, such as the processing circuitry 32, the processor 34, the communication interface 38 or the like, for causing the broadcast signal, such as a discovery signal, to be transmitted to the user equipment in proximity therewith with the broadcast signal including the relay capability of the user equipment. See block 112 of FIG. 6. In one embodiment, the broadcast signal may also include an identification of the serving cell of the user equipment. The identification of the serving cell may also serve as an indication of the relay capability of the user equipment so that separate signals need not always be provided. The apparatus embodied by or otherwise associated with the user equipment 16 may also include means, such as the processing circuitry, the processor, the communication interface or the like, for establishing a connection with the user equipment 10 that experienced the radio link failure. See block 114. In an instance in which the broadcast signal included the relay capability of the user equipment and in which the user equipment was selected to serve as a relay for the user equipment 10, the apparatus embodied by or otherwise associated with user equipment 16 may include means, such as the processing circuitry, the processor, the communication interface or the like, for causing one or more messages to be relayed between user equipment 10 and a network, e.g., base station of serving cell 12, such that connection may be reestablished therebetween. See block 116.

As also shown in FIG. 6, in an instance in which the apparatus 30, such as the processing circuitry 32, the processor 34 or the like, determines that the relay capability of the user equipment should not be included within the broadcast signal, the apparatus may include means, such as the processing circuitry, the processor, the communication interface 38 or the like, for causing the broadcast signal to be transmitted without an indication of the relay capability. See block 188. In some instances, the apparatus, such as the processing circuitry, the processor, the communication interface or the like, may thereafter establish a connection with the other user equipment, but user equipment 16 will not serve as a relay to the network 14 in this instance. See block 120.

As such, a method, apparatus and computer program product of an example embodiment may utilize other user equipment as a relay in order to reestablish connection to a network following a radio link failure. In an example embodiment, a method, apparatus and computer program product may be implemented by the user equipment that experienced the radio link failure or a base station to select the other user equipment to serve as a relay to the network based on one or more parameters such that the resulting connection to the network may be established in an efficient manner. In another example embodiment, a method, apparatus and computer program product may be implemented by the user equipment that serves as a relay to control the instances in which the user equipment broadcasts its relay capabilities so as to increase the likelihood that the user equipment will successfully serve as a relay to the network if selected by the user equipment that has experienced the radio link failure.

As described above, FIGS. 3, 5 and 6 are flowcharts illustrating the operations performed by a method, apparatus and computer program product, such as apparatus 30 of FIG. 2, from the perspective of the user equipment 10 that suffers the radio link failure in regards to FIG. 3, the base station that communicates with the relaying user equipment 16 in regards to FIG. 5 and the user equipment 16 that serves as a relay to facilitate reestablishment of communication with the network in regards to FIG. 6 in accordance with one embodiment of the present invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a non-transitory memory 36 of an apparatus employing an embodiment of the present invention and executed by a processor 34 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart blocks. These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks. As such, the operations of FIGS. 3, 5 and 6, when executed, convert a computer or processing circuitry into a particular machine configured to perform an example embodiment of the present invention. Accordingly, the operations of FIGS. 3, 5 and 6 define an algorithm for configuring a computer or processing circuitry, e.g., processor, to perform an example embodiment. In some cases, a general purpose computer may be provided with an instance of the processor which performs the algorithm of FIGS. 3, 5 and 6 to transform the general purpose computer into a particular machine configured to perform an example embodiment.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified as described below. It should be appreciated that each of the modifications, optional additions or amplifications below may be included with the operations above either alone or in combination with any others among the features described herein. In this regard,

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for establishing a device-to-device connection comprising:
receiving signals from a plurality of user equipment that indicates that the user equipment have relay capabilities;
selecting a respective user equipment to serve as a relay to a network based upon one or more parameters; and
establishing a connection with the respective user equipment that relays messages to the network.

2. A method according to claim 1 wherein selecting the respective user equipment comprises establishing relative priorities for the one or more parameters.

3. A method according to claim 2 wherein establishing relative priorities comprises individually weighting the one or more parameters.

4. A method according to claim 2 wherein establishing relative priorities comprises modifying the priority of a respective parameter as a function of time.

5. A method according to claim 1 wherein the one or more parameters include a serving cell of the user equipment, and wherein selecting the respective user equipment comprises prioritizing user equipment having the same serving cell as that which was utilized prior to radio link failure.

6. A method according to claim 1 wherein the one or more parameters comprise a signal strength to the user equipment.

7. A method according to claim 1 wherein the one or more parameters comprise a relaying capability level of the user equipment.

8. A method according to claim 1 further comprising causing a radio link failure report to be transmitted via the respective user equipment to the network, wherein the radio link failure report includes an identity of a serving cell that was utilized prior to radio link failure.

9. A method according to claim 1 wherein selecting the respective user equipment comprises selecting the respective user equipment following radio link failure.

10. A method according to claim 1 wherein selecting the respective user equipment comprises selecting the respective user equipment in an out-of-network coverage condition.

11. An apparatus for establishing a device-to-device connection comprising:
at least one processor;
at least one memory including computer program code, the at least one memory and the computer program code configured to, with the at least one processor, cause the apparatus at least to perform:
receiving signals from a plurality of user equipment that indicates that the user equipment have relay capabilities;
selecting a respective user equipment to serve as a relay to a network based upon one or more parameters; and
establishing a connection with the respective user equipment that relays messages to the network.

12. An apparatus according to claim 11 wherein the at least one memory and the computer program code are configured to, with the at least one processor, cause the apparatus to select the respective user equipment by establishing relative priorities for the one or more parameters.

13. An apparatus according to claim 12 wherein the at least one memory and the computer program code are configured to, with the at least one processor, cause the apparatus to establish relative priorities by individually weighting the one or more parameters.

14. An apparatus according to claim 12 wherein the at least one memory and the computer program code are configured to, with the at least one processor, cause the apparatus to establish relative priorities by modifying the priority of a respective parameter as a function of time.

15. An apparatus according to claim 11 wherein the one or more parameters include a serving cell of the user equipment, and wherein the at least one memory and the computer program code are configured to, with the at least one processor, cause the apparatus to select the respective user equipment by prioritizing user equipment having the same serving cell as that which was utilized prior to radio link failure.

16. An apparatus according to claim 11 wherein the one or more parameters comprise a signal strength to the user equipment.

17. An apparatus according to claim 11 wherein the one or more parameters comprise a relaying capability level of the user equipment.

18-23. (canceled)

24. A computer readable medium comprising a set of instructions which, when executed, cause a device-to-device connection to be established by:
receiving signals from a plurality of user equipment that indicates that the user equipment have relay capabilities;
selecting a respective user equipment to serve as a relay to a network based upon one or more parameters; and
establishing a connection with the respective user equipment that relays messages to the network.

25. A computer readable medium according to claim 24 wherein selecting the respective user equipment comprises establishing relative priorities for the one or more parameters.

26. A computer readable medium according to claim 25 wherein establishing relative priorities comprises individually weighting the one or more parameters.

27.-89. (canceled)
